(19) United States
(12) Patent Application Publication
(10) Pub. No.: US 2026/0270151 A1
(43) Pub. Date: Sep. 10, 2026

(54) BOT FARM DETECTION WITH TIERED-PRIVILEGE OBSERVABLES

(71) Applicant: T-Mobile USA, Inc., Bellevue, WA (US)

(72) Inventors: Ryan LINDSTROM, Olathe, KS (US); Baewon SEO, Overland Park, KS (US)

(21) Appl. No.: 19/075,769

(22) Filed: Mar. 10, 2025

(51) Int. Cl. H04L 41/14; H04L 41/16; H04L 41/5009

(52) U.S. Cl. CPC H04L 41/14; H04L 41/16; H04L 41/5009

(57) ABSTRACT

Solutions are disclosed that provide for bot farm detection with tiered-privilege observables of device behavior. The observables include network communication data, device hardware data, privileged or permissioned app data, and non-privileged app data, in descending order of privilege. Different entities have differing access, for example telco providers have access to all tiers, due to their role in operating the network and provisioning devices. Device manufacturers and OS providers have access to all but network communication data (the top tier), due to hooks they may have placed into devices. Providers of apps that integrate with website operations have middle-tier access. Regular website providers (that are visited only by browsers) have access to only the lowest tier. Each entity uses the best observables, to which it has access, to detect bots. This enables purging bot-related information from KPI data collected for each entity's systems, facilitating superior data-driven decisions for maintenance and upgrades.

### BACKGROUND

Modern cellular networks collect key performance indicators (KPIs) from user equipment (UEs) in order to monitor network performance and identify user experiences. This information may then be used to identify locations in more need for maintenance, repairs, and upgrades. The quality of the collected KPIs directly impacts the efficiency with which the network improvements improve user experience.

Bot farms are networks of devices, whether personal computers (PCs) or even cellular UEs, that perform automated online tasks. Some bot farms perform legitimate services, whereas others may be used for click fraud and sending spam messages. Due to the profit motive of bot farms, some bot farms may employ large numbers of UEs.

Whether operating for legitimate or malicious purposes, when a bot farm uses UEs, the bot farm UEs do not represent the experience of human users. Unfortunately, if a cellular network is collecting KPIs from a set of UEs that includes a bot farm, the KPIs from the large number of bot farm UEs may overwhelm the KPIs collected from UEs with human users. Challenges that are faced by UEs with human users, which network operators will prefer to address over challenges faced by bot farm UEs, may become obscured. This has the potential to unfavorably skew decisions for network improvements.

### SUMMARY

The following summary is provided to illustrate examples disclosed herein, but is not meant to limit all examples to any particular configuration or sequence of operations.

Solutions are disclosed that provide for bot farm detection with tiered-privilege observables of device behavior. Examples collect a set of key performance indicators (KPIs) for each user equipment (UE) of a plurality of UEs; collect a set of tiered-privilege observables of device behavior for each UE of the plurality of UEs, wherein observables in each tier of privilege above a lowest tier of privilege include observables in a next lower tier of privilege, wherein a first tier of privilege comprises network communication data as a top tier of privilege, wherein a second tier of privilege comprises device hardware data, wherein a third tier of privilege comprises privileged application (app) data or permissioned app data, and wherein a fourth tier of privilege comprises non-privileged app data as the lowest tier of privilege; using observables from at least the top tier of privilege and one other tier of privilege, identify UEs acting as bots; clean, from the collected KPIs, KPIs associated with the UEs identified as acting as bots; and generate an update action based on at least the cleaned KPIs. Some examples use a smaller set of tiers, for example by omitting the network communication data or device hardware data.

### BRIEF DESCRIPTION OF THE DRAWINGS

The disclosed examples are described below with reference to the accompanying drawing figures listed below, wherein:

FIG. 1 illustrates an exemplary architecture that advantageously provides for bot farm detection with tiered-privilege observables of device behavior;

FIG. 2 illustrates further detail on how bots are detected in examples of the architecture of FIG. 1;

FIG. 3 illustrates further detail on examples of tiered-privilege for observables that may be used in examples of the architecture of FIG. 1;

FIG. 4 illustrates some specific examples of observables that may be used in examples of the architecture of FIG. 1;

FIG. 5 illustrates combining observables into composite/derived observables, as may occur in examples of the architecture of FIG. 1;

FIG. 6 illustrates an exemplary training arrangement for a machine learning (ML) model, as may be used for examples of the architecture of FIG. 1;

FIGS. 7, 8A, 8B, and 8C illustrate flowcharts of exemplary operations associated with the architecture of FIG. 1; and

FIG. 9 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed that provide for bot farm detection with tiered-privilege observables of device behavior. The observables include network communication data, device hardware data, privileged or permissioned application (app) data, and non-privileged app data, in descending order of privilege. Different entities have differing access, for example telco providers have access to all tiers, due to their role in operating the network and provisioning devices. Device manufacturers and operating system (OS) providers have access to all but network communication data (the top tier), due to hooks they may have placed into devices. Providers of apps that integrate with website operations have middle-tier access. Regular website providers (that are visited only by browsers) have access to only the lowest tier. Each entity uses the best observables, to which it has access, to detect bots. This enables purging bot-related information from key performance indicators (KPI) data collected for each entity's systems, facilitating superior data-driven decisions for maintenance and upgrades.

Aspects of the disclosure improve the detection of devices, such as user equipment (UEs), which are being used as bots, such as in a bot farm. This detection provides a myriad of advantages, including the ability to purge or clean KPIs of bot-influenced data. The superior KPI data may then be leveraged to prioritize resources for network and UE updates that affect UEs with human users. The advantageous operations are accomplished, at least in part, by using observables from at least a top tier of privilege and one other tier of privilege, identifying UEs acting as bots.

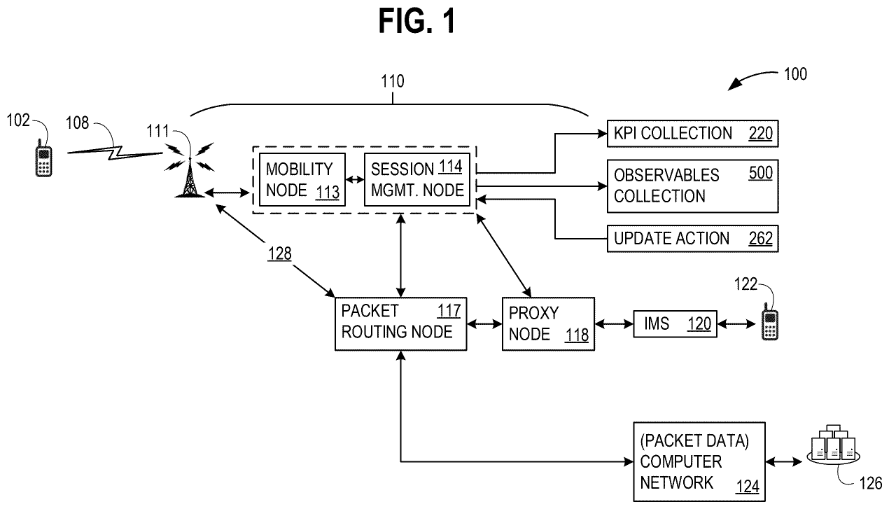

With reference now to the figures, FIG. 1 illustrates an exemplary architecture 100 that advantageously provides for bot farm detection with tiered-privilege observables of device behavior. A wireless network 110 is illustrated that is serving a UE 102. UE 102 may be an enhanced mobile broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network.

In the scene depicted in FIG. 1, UE 102 is using wireless network 110 for a packet data session to reach a network resource 126 (e.g., a website) across an external packet data computer network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

UE 102 uses an air interface 108 to communicate with a base station 111 of wireless network 110, such that base station 111 is the serving base station for UE 102 (providing the serving cell). In some scenarios, base station 111 may be referred to as a radio access network (RAN). Wireless network 110 has a mobility node 113, a session management node 114, and other components (not shown). Wireless network 110 also has a packet routing node 117 and a proxy node 118. Mobility node 113 and session management node 114 are within a control plane of wireless network 110, and packet routing node 117 is within a data plane (a.k.a. user plane) of wireless network 110.

Base station 111 is in communication with mobility node 113 and packet routing node 117. Mobility node 113 is in communication with session management node 114, which is in communication with packet routing node 117, and proxy node 118. Packet routing node 117 is in communication with proxy node 118 and computer network 124. In some 5G examples, base station 111 comprises a gNodeB (gNB), mobility node 113 comprises an access mobility function (AMF), session management node 114 comprises a session management function (SMF), and packet routing node 117 comprises a user plane function (UPF). In some 4G examples, base station 111 comprises an eNodeB (eNB), mobility node 113 comprises a mobility management entity (MME), session management node 114 comprises a system architecture evolution gateway (SAEGW) control plane (SAEGW-C), and packet routing node 117 comprises an SAEGW-user plane (SAEGW-U). In some examples, proxy node 118 comprises a proxy call session control function (P-CSCF) in both 4G and 5G.

Proxy node 118 is in communication with an internet protocol (IP) multimedia system (IMS) 120, which uses an access gateway (IMS-AGW) in order to provide connectivity to other wireless (cellular) networks, such as for a call with a UE 122 or a public switched telephone system (PSTN, also known as plain old telephone system, POTS). In some examples, proxy node 118 may be considered to be within IMS 120. UE 102 reaches network resource 126 using computer network 124 (or IMS 120, in some examples). Data packets of data traffic 128 to/from UE 102 pass through at least base station 111 and packet routing node 117 on their way from/to computer network 124 or IMS 120 (via proxy node 118).

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

As illustrated in further detail in the remaining figures, architecture 100 includes a KPI collection function 220 and an observables collection function 500 that enable selection of an update action 262 that provides an improvement (e.g., maintenance or upgrade) for UE 102 or a component of wireless network 110. Although FIG. 1 and some of the following figures are described using an example of a cellular network, it should be understood that the teachings herein are applicable to other types of wireless networks. To benefit from the teachings herein, another wireless network, other than a cellular network, should collect KPIs and observables. With such features, another type of wireless network, other than a cellular network, may also benefit from the disclosure herein.

Additionally, the teachings herein are also applicable to entities that do not provide wireless connectivity, such as entities that provide wired networks, entities that manufacture UEs, entities that provide an OS for UEs, and entities that provide apps intended to execute on UEs. For example, social media apps that integrate with website operations may benefit from the teachings herein.

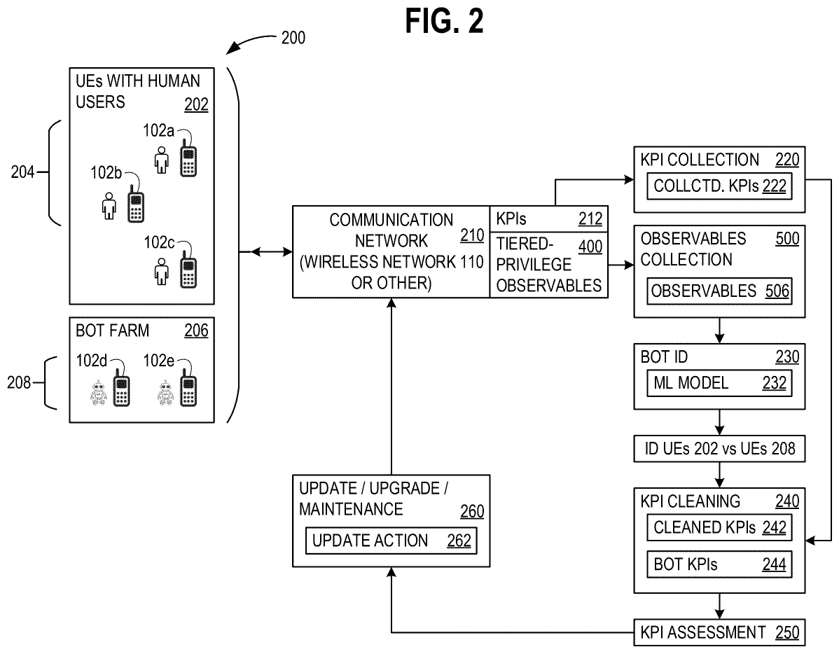

FIG. 2 illustrates further detail on how bots are detected in examples of the architecture of FIG. 1. A plurality of UEs 200, which may include cellular mobile devices and/or PCs, use a communication network 210 that may be an example of wireless network 110 or a wired communication network. Plurality of UEs 200 includes UEs 202 with human users, and also UEs 208 acting as bots in a bot farm 206. UEs 200 includes a UE 102a, a UE 102b, and a UE 102c. UEs 202 includes a UE 102d and a UE 102e. Each of UEs 102a-102e may have the capabilities described for UE 102 of FIG. 1.

A set of KPIs 212 indicates performance of UEs 102a-102e while using communication network 210, and when analyzed, indicate that a set of UEs 204 (of UEs 202) is in need of an update, such as a software update, and/or certain components of communication network 210 are in need of upgrade or maintenance. KPI collection function 220 collects KPIs from set of KPIs 212, creating collected KPIs 222.

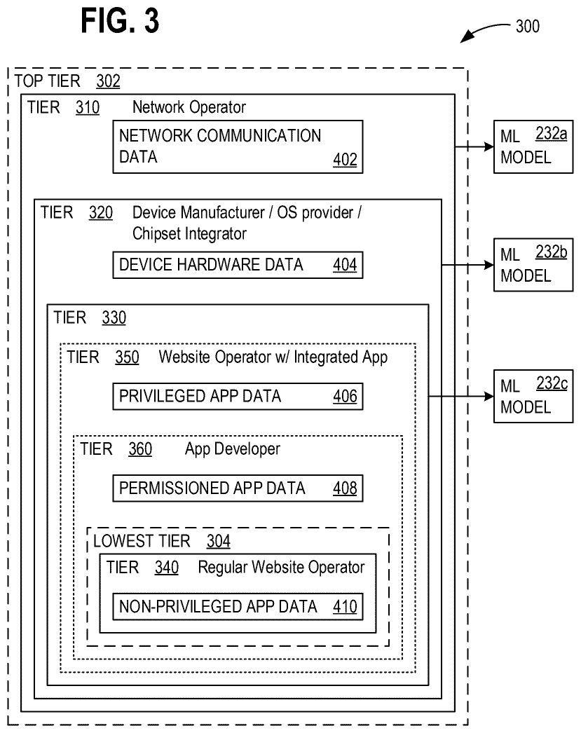

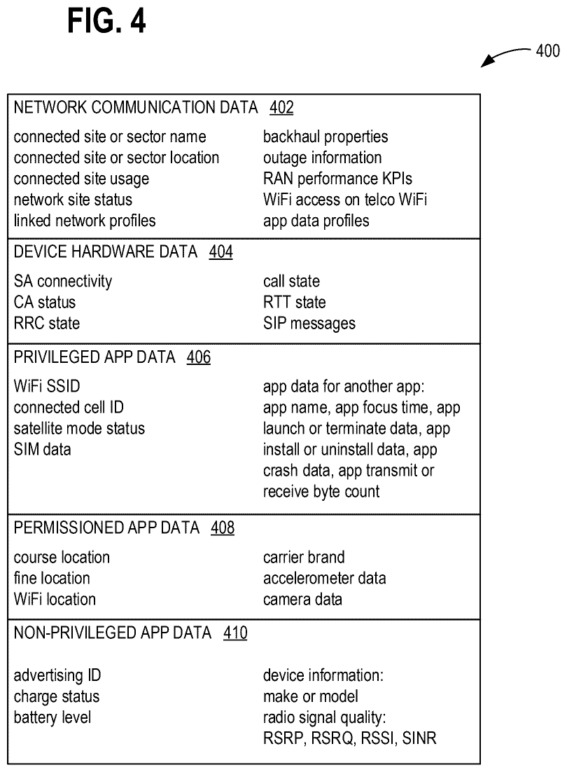

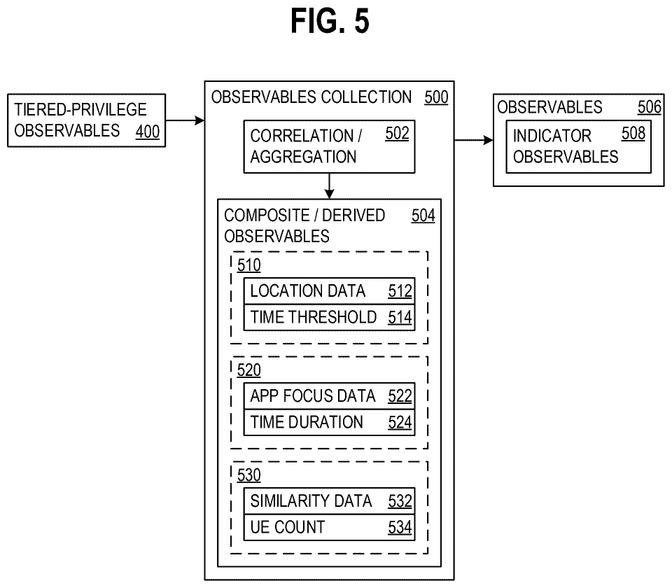

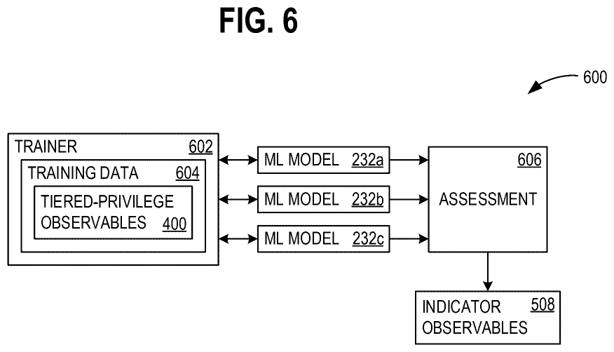

A set of tiered-privilege observables 400 of device behavior is collected by observables collection function 500. Set of tiered-privilege observables 400 is described in further detail in relation to FIGS. 3 and 4. Observables collection function 500 processes set of tiered-privilege observables 400 (e.g., by selection and/or combination, correlation, and derivation) into observables 506 that are used to identify UEs 208 acting as bots. A bot identification function 230 uses a machine learning (ML) model 232 to identify UEs 208 from observables 506. As used herein, ML is synonymous to artificial intelligence (AI). FIG. 6 shows further detail for training of ML model 232, and FIG. 5 shows further detail for processing set of tiered-privilege observables 400 into observables 506.

Bot identification function 230 is able to differentiate between UEs 202 and UEs 208, which is used by a KPI cleaning function 240 to remove KPIs 244 associated with UEs 208 (i.e., bot KPIs) from collected KPIs 222, rendering cleaned KPIs 242. A KPI assessment function 250 is then able to identify which of UEs 202 and/or which components of communication network 210 are most in need of an update, such as an upgrade, repair, or maintenance. This is provided to an Update/upgrade/maintenance function 260 that generates an update action 262. Update action 262 may be a software update, a hardware upgrade schedule, both, or another action.

FIG. 3 illustrates a privilege tier structure 300 for set of tiered-privilege observables 400. Privilege tier structure 300 has a top tier 302 of privilege and a lowest tier 304 of privilege, both of which are relative labels. As indicated, each tier of privilege includes access to observables in the next lower tier of privilege. A set of tiers, including a tier 310, a tier 320, a tier 330, and a tier 340, is illustrated. Tier 340 is also lowest tier 304, although some examples may differ.

In some examples, tier 310, which holds network communication data 402, is top tier 302. Some specific examples of network communication data 402 are shown in FIG. 4. An example entity that has access to network communication data 402 is a network operator (that operates communication network 210), such as a telco operator. When an entity has access to tier 310, that entity also has access to tiers 320, 330, and 340, and uses an ML model 232a in the role of ML model 232 in FIG. 2.

The next lower tier is tier 320, which holds device hardware data 404. Some specific examples of device hardware data 404 are shown in FIG. 4. Some example entities that have access to device hardware data 404 are device manufacturers (that manufacture UEs 102a-102e), an OS provider (that provides OSs for UEs 102a-102e), and a chipset integrator (that provides components, such as processors for UEs 102a-102e). When an entity has access to tier 320, that entity also has access to tiers 330 and 340, and uses an ML model 232b in the role of ML model 232 in FIG. 2. For such an entity, tier 320 is top tier 302 of privilege.

The next lower tier is tier 330, which holds privileged app data 406 and permissioned app data 408. Some specific examples of privileged app data 406 and permissioned app data 408 are shown in FIG. 4. In some examples, tier 330 is split into a tier 350 that holds privileged app data 406 and a tier 360 that holds permissioned app data 408.

Some example entities that have access to privileged app data 406 include website operators that distribute apps that execute on UEs 102a-102e and are integrated with website operations, such as social media apps. Some example entities that have access to permissioned app data 408 are entities that distribute apps for use on UEs 102a-102e, and which are given permissions to access specific data on UEs by the UEs'owners. When an entity has access to tier 330, that entity also has access to tier 340, and uses an ML model 232c in the role of ML model 232 in FIG. 2. For such an entity, tier 330 is top tier 302 of privilege.

The next lower tier is tier 340, which holds non-privileged app data 410. Some specific examples of non-privileged app data 410 are shown in FIG. 4. Some example entities that have access to non-privileged app data 410 are website operators whose websites are accessed by browsers on UEs 102a-102e). Such entities do not have any unique access to date on a UE, and are limited by what is commonly deemed to be non-sensitive information.

FIG. 4 illustrates some specific examples of observables. The examples presented in FIG. 4 are merely exemplary, and not intended to be defining or complete. Some examples may have fewer observables than shown, and some examples may have a larger number than shown. The purpose of FIG. 4 is to illustrate that various entities that are involved with the production and use of UEs 102a-102e have access to different information, based on their roles in relation to UEs 102a-102e.

In the particular example shown, network communication data 402 comprises cellular network communication data, which may include connected site or sector name, connected site or sector location, connected site usage, network site status, backhaul properties, outage information, and RAN performance KPIs. For the illustrated example of cellular UEs, device hardware data 404 may include standalone (SA) connectivity, carrier aggregation (CA) status, radio resource control (RRC) state, call state, real-time text (RTT) state, and session initiation protocol (SIP) messages.

Privileged app data 406 may include WiFi service set identifier (SSID), connected cell identifier (ID), satellite mode status, subscriber identity module (SIM) data, and app data for another app. The app data for another app may include an app name, an app focus time, app launch or terminate data, app install or uninstall data, app crash data, and app transmit or receive byte count. Permissioned app data 408 may include course location, fine location, WiFi location, carrier brand, accelerometer data, and camera data.

Non-privileged app data 410 may include advertising ID, device information, charge status, battery level, and radio signal quality. The device information may be make and/or model. The radio signal quality may be any of reference signal received power (RSRP), reference signal received quality (RSRQ), received signal strength indicator (RSSI), and/or signal to interference plus noise ratio (SINR).

FIG. 5 illustrates combining set of tiered-privilege observables 400 into composite/derived observables 504, which then may form part of observables 506 that are used to identify UEs 208 acting as bots. Additionally, in some examples, observables 506 may be selected as a subset of set of tiered-privilege observables 400, using indicator observables 508, which are described in FIG. 6.

Observables collection function 500 has a composition function 502 that performs composition, derivation, and correlation on set of tiered-privilege observables 400 and using other information, such as timing information, to derive composite/derived observables 504.

Some examples of composite/derived observables 504 include a derived observable 510 that indicates whether a UE has not moved for a time threshold 514. Derived observable 510 uses location data 512 sourced from permissioned app data 408, privileged app data 406, and/or network communication data 402. Location data 512 may be (or be derived from) any of GPS data, an identity of a short-range radio frequency (RF) transmitter, and cellular site sector data. In some examples, time threshold 514 is adjustable, based on common use cases for UEs.

Some examples of composite/derived observables 504 include a derived observable 520 that indicates how long a UE has been focused on a particular app. Some apps may be more likely to be associated with bot behavior than others. Derived observable 520 uses UE app focus information 522 indicating focus on a particular app and a duration 524 of focus determined using timing information. App focus information 522 may be available in privileged app data 406.

Some examples of composite/derived observables 504 include a derived observable 530 that indicates a count 534 of UEs performing a scripted activity that have similar contemporaneous location data and/or movement data 532. Because set of tiered-privilege observables 400 spans plurality of UEs 200, the information from multiple UEs may be compared with each other to identify which UEs are doing the same activities at the same locations. UEs that are all performing the same activity may be counted, giving count 534. The movement data may include cellular site handover (HO) data from network communication data 402.

FIG. 6 illustrates an exemplary training arrangement 600 for ML model 232a, ML model 232b, and/or ML model 232c. A trainer 602 has training data 604, which includes set of tiered-privilege observables 400 (at least those tiers available) to train any of ML model 232a, ML model 232b, and ML model 232c. The specific ML model trained depends on the entity that will use the trained model as ML model 232 (see FIG. 2) for detecting UEs 208 acting as bots. Entities that have access to all tiers of privilege, for example, will use ML model 232a, entities that have access to tiers 320-340 will use ML model 232 b, and entities that have access to only tiers 330 and 340 will use ML model 232c. In some examples, an assessment function 606 identifies which observables have the highest accuracy for detecting bots in each trained ML model, and these are indicator observables 508.

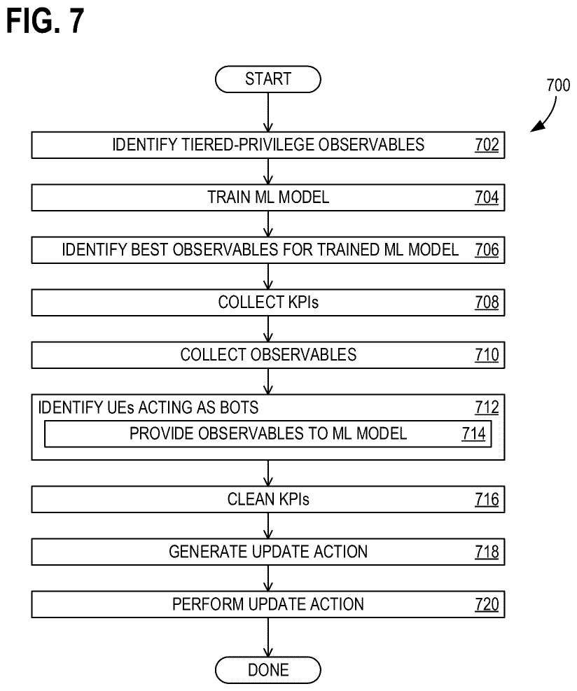

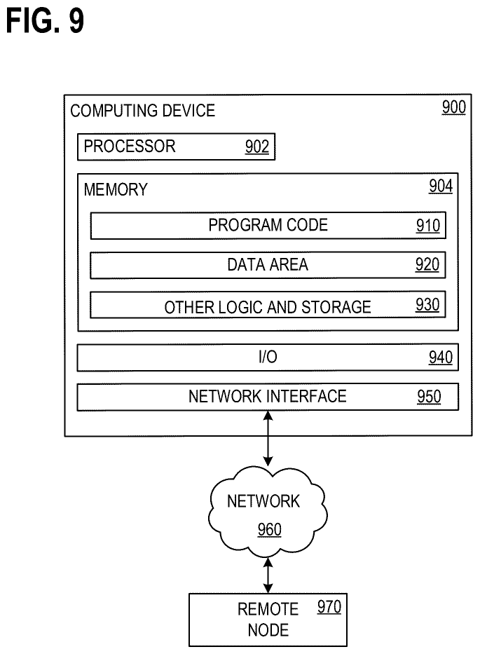

FIG. 7 illustrates a flowchart 700 of exemplary operations associated with examples of architecture 100. In some examples, at least a portion of flowchart 700 may be performed using one or more computing devices 900 of FIG. 9. Flowchart 700 commences with identifying set of tiered-privilege observables 400 of device behavior, in operation 702. In some examples, top tier 302 may be any of tier 310, tier 320, and tier 330.

Operation 704 trains any or all of ML model 232a, ML model 232b, and ML model 232c, using whichever tiers of set of tiered-privilege observables 400 will be available to the entity using the trained ML model(s) for bot detection. Operation 706 identifies indicator observables 508, which are those having a highest accuracy for identifying UEs 208 acting as bots, for whichever of ML model 232a, ML model 232b, and ML model 232c that is being used.

Set of KPIs 212 is collected for each UE of plurality of UEs 200 in operation 708, producing collected KPIs 222. Set of tiered-privilege observables 400 of device behavior are collected for each UE of plurality of UEs 200 in operation 710. Operation 712 uses observables from at least top tier 302 and at least one other tier of privilege to identify UEs 208 acting as bots. In some examples operation 712 is performed using operation 714 that provides observables 506 to ML model 232, which is whichever of ML model 232a, ML model 232b, and ML model 232c that corresponds to the privilege tier to which the entity performing flowchart 700 has access.

Operation 716 cleans collected KPIs 222, removing KPIs 244 associated with UEs 208 identified as acting as bots, thereby producing cleaned KPIs 242. Operation 718 generates update action 262 based on at least cleaned KPIs 242. In some examples, update action 262 comprises a software update and/or a hardware upgrade schedule. Operation 720 comprises performing update action 262 on communication network 210 and/or on set of UEs 204.

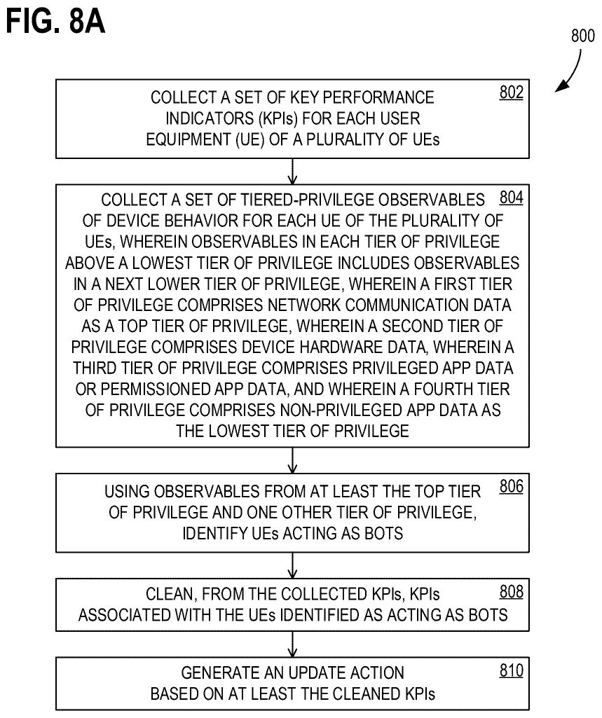

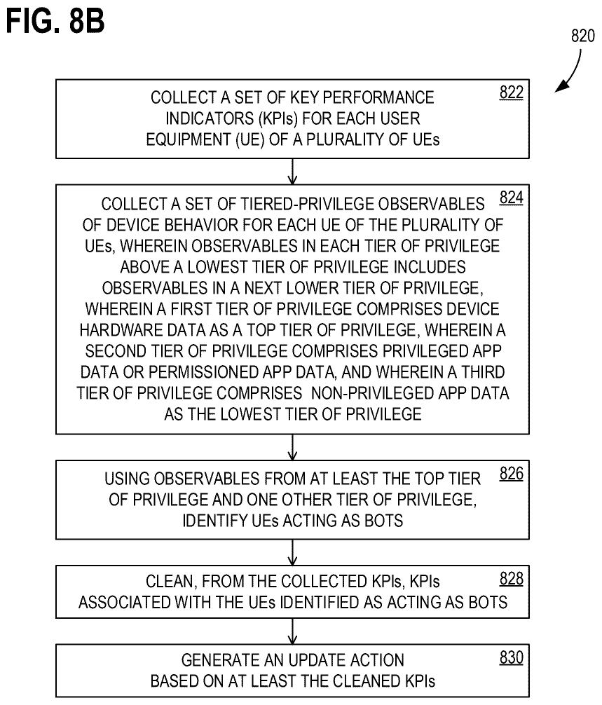

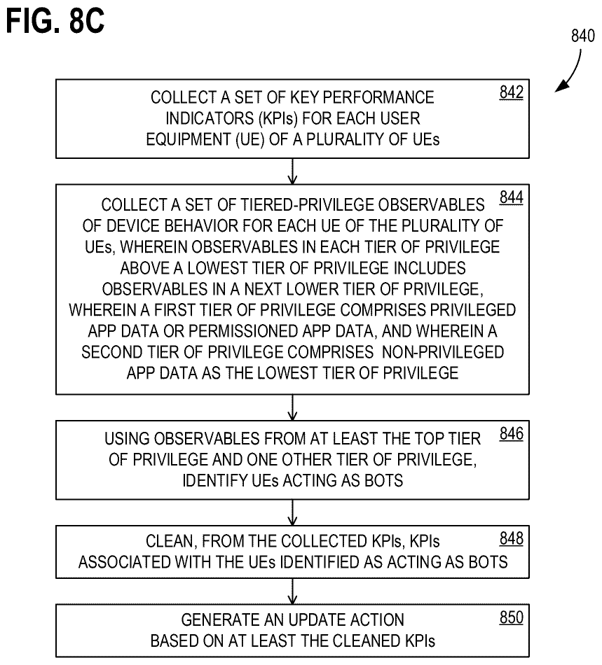

FIG. 8A illustrates a flowchart 800 of exemplary operations associated with architecture 100. In some examples, at least a portion of flowchart 800 may be performed using one or more computing devices 900 of FIG. 9. Flowchart 800 commences with operation 802, which includes collecting a set of KPIs for each UE of a plurality of UEs.

Operation 804 includes collecting a set of tiered-privilege observables of device behavior for each UE of the plurality of UEs, wherein observables in each tier of privilege above a lowest tier of privilege include observables in a next lower tier of privilege, wherein a first tier of privilege comprises network communication data as a top tier of privilege, wherein a second tier of privilege comprises device hardware data, wherein a third tier of privilege comprises privileged app data or permissioned app data, and wherein a fourth tier of privilege comprises non-privileged app data as the lowest tier of privilege.

Operation 806 includes using observables from at least the top tier of privilege and one other tier of privilege, identifying UEs acting as bots. Operation 808 includes cleaning, from the collected KPIs, KPIs associated with the UEs identified as acting as bots. Operation 810 includes generating an update action based on at least the cleaned KPIs.

FIG. 8B illustrates a flowchart 820 of exemplary operations associated with architecture 100. In some examples, at least a portion of flowchart 820 may be performed using one or more computing devices 900 of FIG. 9. Flowchart 820 commences with operation 822, which includes collecting a set of KPIs for each UE of a plurality of UEs.

Operation 824 includes collecting a set of tiered-privilege observables of device behavior for each UE of the plurality of UEs, wherein observables in each tier of privilege above a lowest tier of privilege include observables in a next lower tier of privilege, wherein a first tier of privilege comprises device hardware data as a top tier of privilege, wherein a second tier of privilege comprises privileged app data or permissioned app data, and wherein a third tier of privilege comprises non-privileged app data as the lowest tier of privilege.

Operation 826 includes using observables from at least the top tier of privilege and one other tier of privilege, identifying UEs acting as bots. Operation 828 includes cleaning, from the collected KPIs, KPIs associated with the UEs identified as acting as bots. Operation 830 includes generating an update action based on at least the cleaned KPIs.

FIG. 8C illustrates a flowchart 840 of exemplary operations associated with architecture 100. In some examples, at least a portion of flowchart 840 may be performed using one or more computing devices 900 of FIG. 9. Flowchart 840 commences with operation 842, which includes collecting a set of KPIs for each UE of a plurality of UEs.

Operation 844 includes collecting a set of tiered-privilege observables of device behavior for each UE of the plurality of UEs, wherein observables in each tier of privilege above a lowest tier of privilege include observables in a next lower tier of privilege, wherein a first tier of privilege comprises device hardware data as a top tier of privilege, wherein a second tier of privilege comprises privileged app data or permissioned app data, and wherein a third tier of privilege comprises non-privileged app data as the lowest tier of privilege.

Operation 846 includes using observables from at least the top tier of privilege and one other tier of privilege, identifying UEs acting as bots. Operation 848 includes cleaning, from the collected KPIs, KPIs associated with the UEs identified as acting as bots. Operation 850 includes generating an update action based on at least the cleaned KPIs.

FIG. 9 illustrates a block diagram of computing device 900 that may be used as any component described herein that may require computational or storage capacity (e.g., a computer storage device). Computing device 900 has at least a processor 902 and a memory 904 that holds program code 910, data area 920, and other logic and storage 930. Memory 904 is any device allowing information, such as computer executable instructions and/or other data, to be stored and retrieved. For example, memory 904 may include one or more random access memory (RAM) modules, flash memory modules, hard disks, solid-state disks, persistent memory devices, and/or optical disks. Program code 910 comprises computer executable instructions and computer executable components including instructions used to perform operations described herein. Data area 920 holds data used to perform operations described herein. Memory 904 also includes other logic and storage 930 that performs or facilitates other functions disclosed herein or otherwise required of computing device 900. An input/output (I/O) component 940 facilitates receiving input from users and other devices and generating displays for users and outputs for other devices. A network interface 950 permits communication over external computer network 960 (e.g., computer network 124) with a remote node 970, which may represent another implementation of computing device 900. For example, a remote node 970 may represent another of the above-noted nodes within architecture 100.

### Additional Examples

An example system comprises: a processor; and a computer-readable medium storing instructions that are operative upon execution by the processor to: collect a set of KPIs for each UE of a plurality of UEs; collect a set of tiered-privilege observables of device behavior for each UE of the plurality of UEs, wherein observables in each tier of privilege above a lowest tier of privilege include observables in a next lower tier of privilege, wherein a first tier of privilege comprises network communication data as a top tier of privilege, wherein a second tier of privilege comprises device hardware data, wherein a third tier of privilege comprises privileged app data or permissioned app data, and wherein a fourth tier of privilege comprises non-privileged app data as the lowest tier of privilege; using observables from at least the top tier of privilege and one other tier of privilege, identify UEs acting as bots; clean, from the collected KPIs, KPIs associated with the UEs identified as acting as bots; and generate an update action based on at least the cleaned KPIs.

An example method of wireless communication comprises: collecting a set of KPIs for each UE of a plurality of UEs; collecting a set of tiered-privilege observables of device behavior for each UE of the plurality of UEs, wherein observables in each tier of privilege above a lowest tier of privilege include observables in a next lower tier of privilege, wherein a first tier of privilege comprises network communication data as a top tier of privilege, wherein a second tier of privilege comprises device hardware data, wherein a third tier of privilege comprises privileged app data or permissioned app data, and wherein a fourth tier of privilege comprises non-privileged app data as the lowest tier of privilege; using observables from at least the top tier of privilege and one other tier of privilege, identifying UEs acting as bots; cleaning, from the collected KPIs, KPIs associated with the UEs identified as acting as bots; and generating an update action based on at least the cleaned KPIs.

One or more example computer storage devices has computer-executable instructions stored thereon, which, upon execution by a computer, cause the computer to perform operations comprising: collecting a set of KPIs for each UE of a plurality of UEs; collecting a set of tiered-privilege observables of device behavior for each UE of the plurality of UEs, wherein observables in each tier of privilege above a lowest tier of privilege include observables in a next lower tier of privilege, wherein a first tier of privilege comprises network communication data as a top tier of privilege, wherein a second tier of privilege comprises device hardware data, wherein a third tier of privilege comprises privileged app data or permissioned app data, and wherein a fourth tier of privilege comprises non-privileged app data as the lowest tier of privilege; using observables from at least the top tier of privilege and one other tier of privilege, identifying UEs acting as bots; cleaning, from the collected KPIs, KPIs associated with the UEs identified as acting as bots; and generating an update action based on at least the cleaned KPIs.

Alternatively, or in addition to the other examples described herein, examples include any combination of the following:
the communication network comprises a cellular network;
at least one UE comprises a cellular phone, an eMBB, an FWA device, or a computer with a cellular modem;
the first tier of privilege comprises device hardware data as the top tier of privilege, the second tier of privilege comprises privileged app data or permissioned app data, and the third tier of privilege comprises non-privileged app data as the lowest tier of privilege;
the first tier of privilege comprises privileged app data or permissioned app data as the top tier of privilege, and the second tier of privilege comprises non-privileged app data as the lowest tier of privilege;
the update action comprises a software update;
the update action comprises a hardware upgrade schedule;
performing the update action on a communication network;
performing the update action on a set of UEs of the plurality of UEs;
identifying the UEs acting as bots comprises providing the observables used to identify the UEs acting as bots to an ML model;
training the ML model using the set of tiered-privilege observables;
identifying, for the ML model, indicator observables of the set of tiered-privilege observables having a highest accuracy identifying the UEs acting as bots;
the observables used to identify the UEs acting as bots comprise the indicator observables;
the observables used to identify the UEs acting as bots comprise location data indicating whether a UE has not moved for a threshold amount of time;
the observables used to identify the UEs acting as bots comprise UE focus information indicating focus on a particular app and a duration of focus;
the observables used to identify the UEs acting as bots comprise identification of a count of UEs performing a scripted activity that have similar contemporaneous location data and/or movement data;
the network communication data comprises at least one observable selected from the list consisting of: connected site or sector name, connected site or sector location, connected site usage, network site status, backhaul properties, outage information, and RAN performance KPIs;
the device hardware data comprises at least one observable selected from the list consisting of: SA connectivity, CA status, RRC state, call state, RTT state, and SIP messages;
the privileged app data comprises at least one observable selected from the list consisting of: WiFi SSID, connected cell ID, satellite mode status, SIM data, and app data for another app;
the permissioned app data comprises at least one observable selected from the list consisting of: course location, fine location, WiFi location, carrier brand, accelerometer data, and camera data;
the non-privileged app data comprises at least one observable selected from the list consisting of: advertising ID, device information, charge status, battery level, and radio signal quality;
identifying the set of tiered-privilege observables of device behavior;
the second tier of privilege is above the third tier of privilege;
the third tier of privilege is above the fourth tier of privilege;
the observables in each tier of privilege above the lowest tier of privilege includes all observables in the next lower tier of privilege;
the plurality of UEs comprises mobile devices;
the network communication data comprises cellular network communication data;
the threshold amount of time is adjustable;
the location data comprises GPS data, an identity of a short-range RF transmitter, or cellular site sector data;
the movement data comprises cellular site HO data;
the third tier is further segmented into a fifth tier and a sixth tier;
the fifth tier comprises privileged app data;
the sixth tier comprises permissioned app data;
the app data for another app comprises an app name, an app focus time, app launch or terminate data, app install or uninstall data, app crash data, and app transmit or receive byte count;
the device information comprises make or model; and
the radio signal quality comprises RSRP, RSRQ, RSSI, and/or SINR.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
collecting a set of key performance indicators (KPIs) for each user equipment (UE) of a plurality of UEs;
collecting a set of tiered-privilege observables of device behavior for each UE of the plurality of UEs,
wherein observables in each tier of privilege above a lowest tier of privilege include observables in a next lower tier of privilege,
wherein a first tier of privilege comprises network communication data as a top tier of privilege,
wherein a second tier of privilege comprises device hardware data,
wherein a third tier of privilege comprises privileged application (app) data or permissioned app data, and
wherein a fourth tier of privilege comprises non-privileged app data as the lowest tier of privilege;
using observables from at least the top tier of privilege and one other tier of privilege, identifying UEs acting as bots;
cleaning, from the collected set of KPIs, KPIs associated with the UEs identified as acting as bots; and
generating an update action based on at least the cleaned KPIs.

2. The method of claim 1, wherein the update action comprises a software update or a hardware upgrade schedule, and wherein the method further comprises:
performing the update action on a communication network or a set of UEs of the plurality of UEs.

3. The method of claim 1, wherein identifying the UEs acting as bots comprises:
providing the observables used to identify the UEs acting as bots to a machine learning (ML) model.

4. The method of claim 3, wherein the method further comprises:
training the ML model using the set of tiered-privilege observables.

5. The method of claim 4, wherein the method further comprises:
identifying, for the ML model, indicator observables of the set of tiered-privilege observables having a highest accuracy identifying the UEs acting as bots, wherein the observables used to identify the UEs acting as bots comprise the indicator observables.

6. The method of claim 1, wherein the observables used to identify the UEs acting as bots comprise:
location data indicating whether a UE has not moved for a threshold amount of time.

7. The method of claim 1, wherein the observables used to identify the UEs acting as bots comprise:
UE focus information indicating focus on a particular app and a duration of focus.

8. The method of claim 1, wherein the observables used to identify the UEs acting as bots comprise:
identification of a count of UEs performing a scripted activity that have similar contemporaneous location data and/or movement data.

9. The method of claim 1,
wherein the network communication data comprises at least one observable selected from the list consisting of:
connected site or sector name, connected site or sector location, connected site usage, network site status, backhaul properties, outage information, and radio access network (RAN) performance KPIs;
wherein the device hardware data comprises at least one observable selected from the list consisting of:
standalone (SA) connectivity, carrier aggregation (CA) status, radio resource control (RRC) state, call state, real-time text (RTT) state, and session initiation protocol (SIP) messages;
wherein the privileged app data comprises at least one observable selected from the list consisting of:
WiFi service set identifier (SSID), connected cell identifier (ID), satellite mode status, subscriber identity module (SIM) data, and app data for another app;
wherein the permissioned app data comprises at least one observable selected from the list consisting of:
course location, fine location, WiFi location, carrier brand, accelerometer data, and camera data; and
wherein the non-privileged app data comprises at least one observable selected from the list consisting of:
advertising ID, device information, charge status, battery level, and radio signal quality.

10. A system comprising:
a processor; and
a computer-readable medium storing instructions that are operative upon execution by the processor to:
collect a set of key performance indicators (KPIs) for each user equipment (UE) of a plurality of UEs;
collect a set of tiered-privilege observables of device behavior for each UE of the plurality of UEs,
wherein observables in each tier of privilege above a lowest tier of privilege include observables in a next lower tier of privilege,
wherein a first tier of privilege comprises network communication data as a top tier of privilege,
wherein a second tier of privilege comprises device hardware data,
wherein a third tier of privilege comprises privileged application (app) data or permissioned app data, and
wherein a fourth tier of privilege comprises non-privileged app data as the lowest tier of privilege;
using observables from at least the top tier of privilege and one other tier of privilege, identify UEs acting as bots;
clean, from the collected set of KPIs, KPIs associated with the UEs identified as acting as bots; and
generate an update action based on at least the cleaned KPIs.

11. The system of claim 10, wherein identifying the UEs acting as bots comprises:
providing the observables used to identify the UEs acting as bots to a machine learning (ML) model.

12. The system of claim 11, wherein the wherein the instructions are further operative to:
train the ML model using the set of tiered-privilege observables.

13. The system of claim 12, wherein the wherein the instructions are further operative to:
identify, for the ML model, indicator observables of the set of tiered-privilege observables having a highest accuracy identifying the UEs acting as bots, wherein the observables used to identify the UEs acting as bots comprise the indicator observables.

14. The system of claim 10, wherein the observables used to identify the UEs acting as bots comprise:
location data indicating whether a UE has not moved for a threshold amount of time;
UE focus information indicating focus on a particular app and a duration of focus; or
identification of a count of UEs performing a scripted activity that have similar contemporaneous location data and/or movement data.

15. One or more computer storage devices having computer-executable instructions stored thereon, which, upon execution by a computer, cause the computer to perform operations comprising:
collecting a set of key performance indicators (KPIs) for each user equipment (UE) of a plurality of UEs;
collecting a set of tiered-privilege observables of device behavior for each UE of the plurality of UEs,
wherein observables in each tier of privilege above a lowest tier of privilege include observables in a next lower tier of privilege,
wherein a first tier of privilege comprises network communication data as a top tier of privilege,
wherein a second tier of privilege comprises device hardware data,
wherein a third tier of privilege comprises privileged application (app) data or permissioned app data, and
wherein a fourth tier of privilege comprises non-privileged app data as the lowest tier of privilege;
using observables from at least the top tier of privilege and one other tier of privilege, identifying UEs acting as bots;
cleaning, from the collected set of KPIs, KPIs associated with the UEs identified as acting as bots; and
generating an update action based on at least the cleaned KPIs.

16. The one or more computer storage devices of claim 15, wherein identifying the UEs acting as bots comprises:
providing the observables used to identify the UEs acting as bots to a machine learning (ML) model.

17. The one or more computer storage devices of claim 16, wherein the operations further comprise:
training the ML model using the set of tiered-privilege observables.

18. The one or more computer storage devices of claim 15, wherein the observables used to identify the UEs acting as bots comprise:
location data indicating whether a UE has not moved for a threshold amount of time.

19. The one or more computer storage devices of claim 15, wherein the operations further comprise:
UE focus information indicating focus on a particular app and a duration of focus.

20. The one or more computer storage devices of claim 15, wherein the operations further comprise:
identification of a count of UEs performing a scripted activity that have similar contemporaneous location data and/or movement data.
